(19) United States
(12) Patent Application Publication
(10) Pub. No.: US 2024/0304961 A1
(43) Pub. Date: Sep. 12, 2024

(54) LITHIUM SECONDARY BATTERY

(71) Applicant: HONDA MOTOR CO., LTD., Tokyo (JP)

(72) Inventors: Hiroshi SAKAI, Saitama (JP); Hiroshi OGASA, Saitama (JP); Wataru SHIMIZU, Saitama (JP)

(21) Appl. No.: 18/586,547

(22) Filed: Feb. 26, 2024

(30) Foreign Application Priority Data
Mar. 9, 2023 (JP) 2023-036751

(51) Int. Cl. H01M 50/581; H01M 4/134; H01M 4/38; H01M 4/66; H01M 10/04; H01M 10/052; H01M 50/489

(52) U.S. Cl. CPC H01M 50/581; H01M 4/134; H01M 4/382; H01M 4/661; H01M 10/0481; H01M 10/052; H01M 50/489

(57) ABSTRACT

A lithium secondary battery of the present invention comprises: a positive electrode comprising a positive electrode current collector and a positive electrode material mixture layer, a negative electrode comprising a negative electrode current collector and a lithium metal foil, and a separator, and further comprises a thermally deformable separator disposed in the vicinity of the positive electrode material mixture layer on the surface of the positive electrode current collector, and an extension portion that extends from the lithium metal foil so as to be in contact with the thermally deformable separator; the thermally deformable separator having a melting point of 80° C. or higher, which is equal to or lower than the melting point of lithium metal; and when a thermally deformable separator 31 thermally deforms, the extension portion comes into contact with the positive electrode current collector, resulting in a short circuit of the positive electrode and the negative electrode.

This application is based on and claims the benefit of priority from Japanese Patent Application No. 2023-036751, filed on 9 Mar. 2023, the content of which is incorporated herein by reference.

### BACKGROUND OF THE INVENTION

### Field of the Invention

The present invention relates to a lithium secondary battery.

### Related Art

In recent years, research and development have been conducted on secondary batteries that contribute to energy efficiency in order to ensure that more people have access to affordable, reliable, sustainable, and advanced energy. Conventionally, in a secondary battery using lithium or the like, there is known a technique for dealing with a heat problem caused by Joule heat and reaction heat during charge. The heat problem suffered by this type of secondary battery is described, for example, in Patent Documents 1 to 5.

Patent Document 1: Japanese Unexamined Patent Application, Publication No. H10-64549

Patent Document 2: Japanese Unexamined Patent Application, Publication No. H7-192753

Patent Document 3: Japanese Unexamined Patent Application, Publication No. H10-233237

Patent Document 4: Japanese Unexamined Patent Application, Publication No. H11-45740

Patent Document 5: Japanese Unexamined Patent Application, Publication No. H11-233150

### SUMMARY OF THE INVENTION

In the technology relating to the lithium secondary battery, it is necessary to deal with an increase in a temperature due to Joule heat and reaction heat during charge, and at the same time, it is also a problem that the capacity should be increased to further increase energy density. An increase in capacity leads to an increase in temperature at the time of overcharging. In a secondary battery using a lithium metal as a negative electrode, when a temperature at which the lithium metal melts is reached, the reaction occurs at once, and there is a possibility that vigorous thermal runaway occurs. Therefore, it is preferable that the battery be deactivated or an abnormal state be detected before the melting temperature of the lithium metal is reached. However, there was room for improvement in prior art with regard to the point whether severe thermal runaway could be surely avoided.

It is an object of the present invention to provide a highly safe lithium secondary battery capable of avoiding thermal runaway caused by reaching a temperature at which lithium metal melts. This also contributes to energy efficiency.

A first aspect of the present invention relates to a lithium secondary battery including: a positive electrode including a positive electrode current collector and a positive electrode material mixture layer disposed on a surface of the positive electrode current collector, a negative electrode including a negative electrode current collector and a lithium metal foil disposed on a surface of the negative electrode current collector, and a separator disposed between the positive electrode and the negative electrode. In the first aspect, the lithium secondary battery includes: a thermally deformable separator disposed in the vicinity of the positive electrode material mixture layer on the surface of the positive electrode current collector, and an extension portion that extends from the lithium metal foil so as to be in contact with the thermally deformable separator; the thermally deformable separator has a melting point of 80° C. or higher, which is equal to or lower than the melting point of lithium metal; and when the thermally deformable separator thermally deforms, the extension portion comes into contact with the positive electrode current collector, resulting in a short circuit of the positive electrode and the negative electrode.

A second aspect of the present invention relates to the lithium secondary battery as described in the first aspect, in which the positive electrode current collector may be an aluminum foil.

A third aspect of the present invention relates to the lithium secondary battery as described in the first or second aspect, in which the extension portion of the lithium metal foil may be configured to come into contact with the positive electrode current collector when the thermally deformable separator is thermally deformed by a restraint load that restrains the positive electrode, the separator, and the negative electrode.

A fourth aspect of the present invention relates to the lithium secondary battery as described in the third aspect, in which the lithium secondary battery includes an exterior body housing the positive electrode, the negative electrode, and the separator, and a pressure plate that applies a restraint load to pressurize the negative electrode toward the positive electrode side via the exterior body, and the pressure plate may have a projection portion that pressurizes, via the exterior body, the extension portion of the lithium metal foil toward the positive electrode current collector side outside the separator.

A fifth aspect of the present invention relates to the lithium secondary battery as described in any one of the first to fourth aspects, in which the extension portion of the lithium metal foil may be configured to curve or bend toward the positive electrode current collector side in the lamination direction.

A sixth aspect of the present invention relates to the lithium secondary battery as described in any one of the first to fifth aspects, in which the lithium secondary battery has a positive electrode tab having one end portion thereof connected to the positive electrode current collector and the other end portion exposed to the outside, and the extension portion of the lithium metal foil may be disposed in the vicinity of the positive electrode tab.

According to the present invention, it is possible to provide a highly safe lithium secondary battery capable of avoiding thermal runaway caused by lithium metal reaching a temperature at which the lithium metal melts. Consequently, it is possible to contribute to energy efficiency.

### BRIEF DESCRIPTION OF THE DRAWINGS

FIG. 1 is a schematic cross-sectional view showing a state during charge of a lithium secondary battery according to an embodiment of the present invention;

FIG. 2 is a schematic view showing a state of the lithium secondary battery according to the embodiment of the present invention during discharge;

FIG. 3 is a schematic plan view showing an arrangement of extension portions of a lithium metal foil of the lithium secondary battery according to the embodiment of the present invention;

FIG. 4 is a schematic view showing a thermally deformed state of a thermally-shrinkable separator of the lithium secondary battery according to the embodiment of the present invention;

FIG. 5 is a schematic view showing a state in which the extension portion of the lithium metal foil of the lithium secondary battery according to the embodiment of the present invention has disappeared; and

FIG. 6 is a schematic view showing a configuration of a lithium metal of a modified example.

### DETAILED DESCRIPTION OF THE INVENTION

Embodiments of the present invention will now be described with reference to the accompanying drawings.

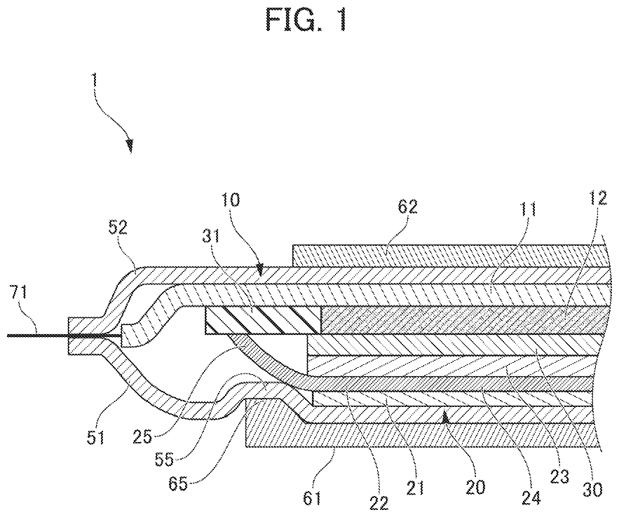

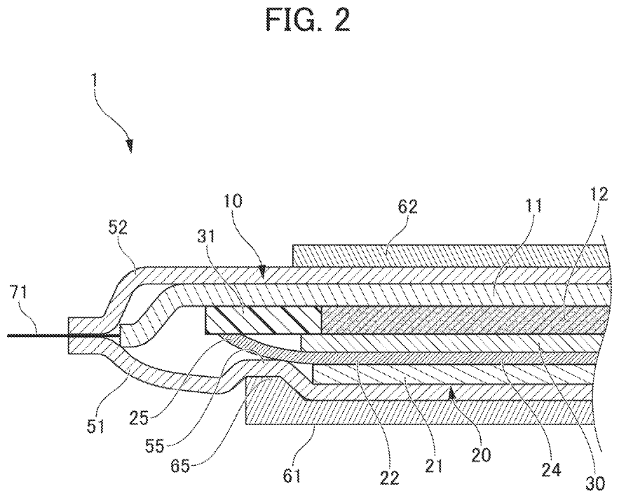

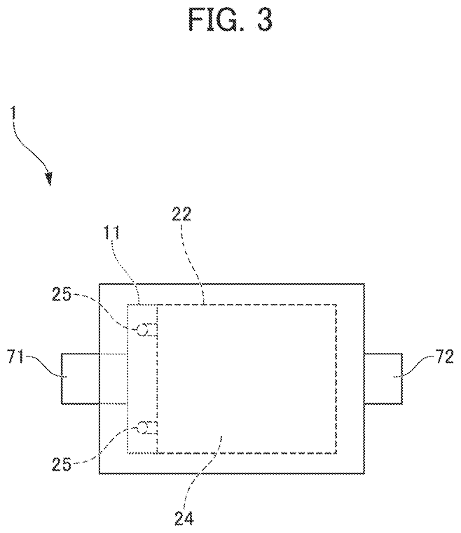

FIG. 1 is a schematic cross-sectional view showing a state during charge of the lithium secondary battery according to an embodiment of the present invention, FIG. 2 is a schematic view showing a state during discharge of the lithium secondary battery, and FIG. 3 is a schematic plan view showing an arrangement of extension portions of the lithium metal foil of the lithium secondary battery. A lithium secondary battery 1 shown in FIGS. 1 to 3 is a lithium metal battery using lithium metal as the negative electrode. The lithium secondary battery 1 is used, for example, in an electric automobile or a hybrid automobile.

The lithium secondary battery 1 of the present embodiment includes a positive electrode 10, a negative electrode 20, a separator 30, a thermally deformable separator 31, an electrolytic solution (not shown), a first exterior body 51, a second exterior body 52, a first pressure plate 61 and a second pressure plate 62.

The positive electrode 10 includes a positive electrode current collector 11 and a positive electrode material mixture layer 12 disposed on a surface of the positive electrode current collector 11. The positive electrode current collector 11 is connected to a positive electrode tab 71.

The positive electrode current collector 11 is not particularly limited, but is composed of a well-known current collecting material used as a positive electrode current collector for lithium secondary batteries. As the positive electrode current collector 11, for example, a metal foil such as an aluminum foil can be used.

The positive electrode material mixture layer 12 contains at least one type of positive electrode active material. The positive electrode material mixture layer 12 is not particularly limited, and those used in a positive electrode layer of general lithium secondary batteries can be used. As the positive electrode material mixture layer 12, for example, a layered active material containing lithium, a spinel active material, an olivine active material, or the like can be used. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), Li-Mn spinel substituted with a heteroatom represented by Li₁₊ₓMn_{2-x-y}MO₄ (x+y=2, M=Al, Mg, Co, Fe, Ni, and Zn), lithium titanate (an oxide containing Li and Ti), and lithium metal phosphate (LiMPO₄, M=at least one selected from Fe, Mn, Co, and Ni).

One end of the positive electrode tab 71 is connected to the positive electrode current collector 11, and the other end is exposed to the outside. The positive electrode tab 71 is sandwiched between the first exterior body 51 and the second exterior body 52.

The negative electrode 20 includes a negative electrode current collector 21 and a lithium metal foil 22 disposed on the surface of the negative electrode current collector 21. As shown in FIG. 1, during charge, lithium ions are released from the positive electrode material mixture layer 12, move through the separator 30, and are deposited between the lithium metal foil 22 and the separator 30, generating a lithium metal layer 23 and increasing the thickness of the negative electrode 20. During discharge, lithium ions are released from the lithium metal layer 23 and move to the positive electrode 10 side. Therefore, in the discharge state, the lithium metal layer 23 disappears as shown in FIG. 2. The negative electrode current collector 21 is connected to a negative electrode tab 72 (not shown in FIGS. 1 and 2).

The negative electrode current collector 21 is not particularly limited, but is composed of a known collector material used as a negative electrode current collector of a lithium secondary battery. As the negative electrode current collector 21, for example, a foil of a metal such as copper can be used.

The lithium metal foil 22 functions as a nucleus for deposited lithium ions to form a lithium layer during charge. In the present embodiment, the lithium metal foil 22 has a main body 24 and an extension portion 25 extending from the main body 24. In the present embodiment, two extension portions 25 are convexly arranged so as to sandwich the positive electrode tab 71 (see FIG. 3). Accordingly, the extension portion 25 is positioned in the vicinity of the positive electrode tab 71. The extension portion 25 is held in a curved state by a convex portion 55 of the first exterior body 51. In the present embodiment, during charge or discharge, the extension portion 25 is in contact with the thermally deformable separator 31.

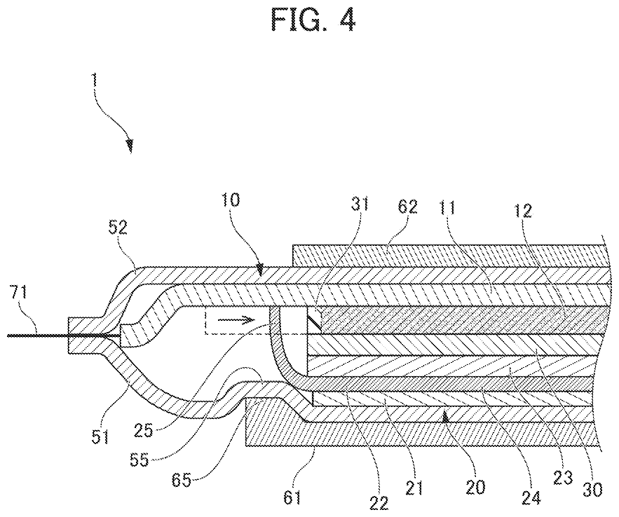

One end of the negative electrode tab 72 is connected to the negative electrode current collector 21, and the other end is exposed to the outside (see FIG. 4). The negative electrode tab 72 is sandwiched between the first exterior body 51 and the second exterior body 52.

The material of the separator 30 is not particularly limited, but, for example, a porous sheet or a nonwoven fabric sheet can be used. Examples of the material of the porous sheet include polyolefins such as polyethylene and polypropylene, aramids, polyimides and fluororesins. Examples of the material of the nonwoven fabric sheet include glass fiber and cellulose fiber.

The thermally deformable separator 31 is disposed in the vicinity of the positive electrode material mixture layer 12 on the surface of the positive electrode current collector 11. The melting point of the thermally deformable separator 31 is 80° C. or higher and the melting point of the lithium metal or lower. In other words, the thermally deformable separator 31 that is thermally shrinkable is formed of a thermally deformable material that shrinks at a temperature lower than the melting point of lithium metal. Examples of the material of the thermally deformable separator 31 include cellophane tape.

The electrolytic solution includes an organic solvent and an electrolyte. Examples of the organic solvent include cyclic carbonates, chain carbonates, cyclic ethers, chain ethers, hydrofluoroethers, aromatic ethers, sulfones, cyclic esters, chain carboxylic acid esters, and nitriles. Examples of the cyclic carbonates include ethylene carbonate, propylene carbonate, vinylene carbonate, and fluoroethylene carbonate. Examples of the chain carbonates include dimethyl carbonate, diethyl carbonate, and ethyl methyl carbonate. Examples of the cyclic ethers include tetrahydrofuran, 2-methyltetrahydrofuran, tetrahydropyran, 1,3-dioxolane, 4-methyl-1,3-dioxolane, and the like. Examples of the chain ethers include 1,2-dimethoxyethane, 1,2-diethoxyethane, ethoxymethoxyethane, and diethyl ether. Examples of the hydrofluoroethers include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl) ether, 1,2-bis(1,1,2,2-tetrafluoroethoxy) ethane, and the like. Examples of the aromatic ethers include anisole. Examples of the sulfones include sulfolane and methylsulfolane. Examples of the cyclic esters include γ-butyrolactone. Examples of the chain carboxylic acid esters include acetate esters, butyrate esters, and propionate esters. Examples of the nitriles include acetonitrile and propionitrile. The organic solvent may be used alone or in combination of two or more types thereof.

The electrolyte is a source of lithium ions which are charge transfer media, and includes a lithium salt. Examples of the lithium salt include LiPF₆, LiBF₄, LiClO₄, LiAsF₆, LiCF₃SO₃, LiC (CF₃SO₂)₃, LiN(CF₃SO₂)₂(LiTFSI), LiN(FSO₂)₂(LiFSI), and LiBC₄O₈. The lithium salt may be used alone or in combination of two or more types thereof.

The first exterior body 51 is positioned in a side closer to the negative electrode 20, and the second exterior body 52 is positioned in a side closer to the positive electrode 10. By sealing the first exterior body 51 and the second exterior body 52, the positive electrode 10, the negative electrode 20, the separator 30, the thermally deformable separator 31, and the electrolytic solution are housed in the exterior body in a sealed state. As a material of the first exterior body 51 and the second exterior body 52, a laminate film can be used. As the laminate film, a laminate film having a three-layer structure in which an inner resin layer, a metal layer, and an outer resin layer are laminated in this order from the inside can be used. The inner resin layer may be, for example, a polyamide (nylon) layer or a polyethylene terephthalate (PET) layer, the metal layer may be, for example, an aluminum layer, and the outer resin layer may be, for example, a polyethylene layer or a polypropylene layer.

The first pressure plate 61 is positioned in the side closer to the negative electrode, and the second pressure plate 62 is positioned in the side closer to the positive electrode. The first pressure plate 61 and the second pressure plate 62 are arranged so as to sandwich the respective components of the lithium secondary battery 1 in the lamination direction. The first pressure plate 61 and the second pressure plate 62 apply a restraint load in the lamination direction to secure a sufficient contact area of interfaces between layers.

The first pressure plate 61 of the present embodiment has a projection portion 65 that is bent inward. The projection portion 65 forms the convex portion 55 in the first exterior body 51.

An example of the configuration of the lithium secondary battery 1 during charge and discharge has been described above. Next, the behavior of the lithium secondary battery 1 in a high temperature state in which the thermally deformable separator 31 thermally shrinks will be described.

FIG. 4 is a schematic view showing a state in which the thermally deformable separator 31 of the lithium secondary battery 1 according to the embodiment of the present invention has thermally shrunk (has thermally deformed). As shown in FIG. 4, when a large current due to a short circuit or the like is applied, the largest amount of heat is generated at the positive electrode tab 71, and the thermally deformable separator 31 shrinks into the positive electrode material mixture layer 12 side by the generated heat. The extension portion 25 of the lithium metal foil 22 is being pressed toward the positive electrode current collector 11 side by the convex portion 55 of the first exterior body 51 due to the restraint load of the projection portion 65 of the first pressure plate 61. Therefore, when the thermally deformable separator 31 that is in contact with the extension portion 25 of the lithium metal foil 22 disappears due to thermal shrinkage, the extension portion 25 of the lithium metal foil 22 is pushed into the positive electrode side and comes into contact with a surface of the positive electrode current collector 11 exposed due to the disappearance of the thermally deformable separator 31. The positive electrode current collector 11 comes into contact with the extension portion 25 of the lithium metal foil 22, thereby resulting in a state where the positive electrode 10 and the negative electrode 20 are short-circuited.

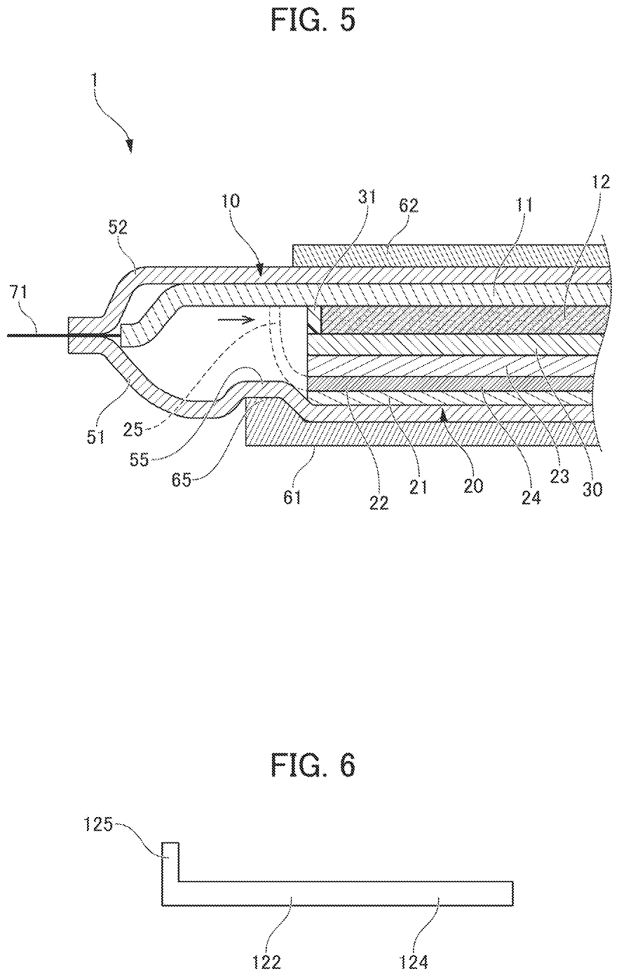

FIG. 5 is a schematic view showing a state in which the extension portion 25 of the lithium metal foil 22 of the lithium secondary battery 1 according to the embodiment of the present invention has disappeared. As shown in FIG. 5 and the following formula (1), when the extension portion 25 of the lithium metal foil 22 comes into contact with the positive electrode current collector 11, lithium in the extension portion 25 of the lithium metal foil 22 is taken into the positive electrode current collector 11, and the extension portion 25 disappears. In the formula (1), Al denotes the positive electrode current collector 11. Al+xLi⁺+xe→LiₓAl (1)

As described above, the lithium secondary battery 1 of the present embodiment includes the thermally deformable separator 31 disposed in the vicinity of the positive electrode material mixture layer 12 on the surface of the positive electrode current collector 11 and the extension portion 25 extended from the lithium metal foil 22 so as to contact the thermally deformable separator 31, and when the thermally deformable separator 31 thermally deforms (thermally shrinks), the extension portion 25 comes into contact with the positive electrode current collector 11, resulting in a short circuit between the positive electrode 10 and the negative electrode 20. In the lithium secondary battery 1 of the present embodiment, the melting point of the thermally deformable separator 31 is 80° C. or higher, which is equal to or lower than the melting point of lithium metal, and thus the positive electrode 10 and the negative electrode 20 can be short-circuited at a temperature equal to or lower than the melting point of lithium metal. Therefore, according to the lithium secondary battery 1 of the present embodiment, thermal runaway caused by reaching a temperature at which lithium metal melts can be avoided.

In addition, in the lithium secondary battery 1 of the present embodiment, the extension portion 25 of the lithium metal foil 22 is arranged in a convex shape only in two locations so as to sandwich the positive electrode tab 71. Therefore, an amount of the lithium metal foil 22 in the vicinity of the positive electrode tab 71 can be reduced as compared with a configuration in which the extension portion 25 of the lithium metal foil 22 is formed over the entire end surface of the main body 24. Since the amount of the lithium metal foil 22 to be short-circuited is small, the short circuit itself in the lithium secondary battery 1 can be terminated on a small scale.

In the lithium secondary battery 1 of the present embodiment, the positive electrode current collector 11 is made of aluminum foil. This enables the positive electrode current collector 11 to incorporate lithium in the extension portion 25 of the lithium metal foil 22 and thereby make the extension portion 25 disappear, and thus a short-circuited state between the positive electrode 10 and the negative electrode 20 can be terminated on a smaller scale.

Further, in the lithium secondary battery 1 of the present embodiment, the extension portion 25 of the lithium metal foil 22 is configured to contact the positive electrode current collector 11 when the thermally deformable separator 31 is thermally deformed by the restraint load that restrains the positive electrode 10, the negative electrode 20, and the separator 30. This makes it possible to reliably generate contact between the extension portion 25 and the positive electrode current collector 11 using the restraint load.

In addition, the lithium secondary battery 1 of the present embodiment includes the first exterior body 51 and the second exterior body 52 that house the positive electrode 10, the negative electrode 20, and the separator 30, and the first pressure plate 61 and the second pressure plate 62 that pressurize the negative electrode 20 toward the positive electrode 10 side via the first exterior body 51 and the second exterior body 52 to apply a restraint load. The first pressure plate 61 includes the projection portion 65 that pressurizes, via the first exterior body 51, the extension portion 25 of the lithium metal foil 22 to the positive electrode current collector 11 side outside the separator 30. Thus, since the projection portion 65 pressurizes the extension portion 25 toward the positive electrode current collector 11 side outside the separator 30, a short circuit between the extension portion 25 and the positive electrode current collector 11 during thermal deformation can be more reliably achieved at a more appropriate position.

In the lithium secondary battery 1 of the present embodiment, the extension portion 25 of the lithium metal foil is disposed in the vicinity of the positive electrode tab 71. By disposing the extension portion 25 in the vicinity of the positive electrode tab 71 that will receive the largest amount of heat generated in the abnormal state such as a case where a large current is applied due to a short circuit or the like, the positive electrode 10 and the negative electrode 20 can be quickly short-circuited in the abnormal state.

Further, in the lithium secondary battery 1 of the present embodiment, the extension portion 25 of the lithium metal foil 22 is configured to be curved toward the positive electrode current collector 11 side in the lamination direction. Thereby, curvature of the extension portion 25 of the lithium metal foil 22 generates flexibility. When the thermally deformable separator 31 thermally deforms, a short circuit between the extension portion 25 and the positive electrode current collector 11 can be more reliably achieved by utilizing the flexibility.

In the above-described embodiment, the extension portion 25 of the lithium metal foil 22 is configured to be curved but the present invention is not limited to this embodiment. Next, with reference to FIG. 6, a lithium metal foil 122 having a structure different from that of the above embodiment will be described. FIG. 6 is a schematic view showing a configuration of the lithium metal foil 122 according to a modified example. As shown in FIG. 6, an extension portion 125 of the lithium metal foil 122 of the modified example is configured to be curved toward the positive electrode current collector 11 side in the lamination direction. The extension portion 125 protrudes in a convex shape from a main body 124. Also in this configuration, as the thermally deformable separator 31 thermally shrinks and disappears, the extension portion 125 of the lithium metal foil 122 is extended by heat to contact the positive electrode current collector 11. Since the extension portion 125 is bent, an amount of movement until the extension portion 125 comes into contact with the positive electrode current collector 11 can be reduced as compared with a case where the extension portion 125 is not bent, and a short circuit can be more easily achieved.

In the above embodiment, the thermally deformable separator 31 has been described as being thermally shrinkable, but the thermal deformation of the thermally deformable separator 31 is not limited thereto. Besides shrinkage, a material that disappears by heat can also be used as the thermally deformable separator.

Although the lithium secondary battery 1 in which the electrolyte is an electrolytic solution has been described in the above embodiment, the present invention is not limited to this configuration. For example, the present invention can also be applied to a solid electrolyte in which the electrolyte is solid. As the solid electrolyte, for example, a sulfide solid electrolyte, an oxide solid electrolyte, a nitride solid electrolyte, a halide solid electrolyte, or the like can be used. Examples of the sulfide solid electrolytes include Li₂S—P₂S₅ and Li₂S—P₂S₅—LiI. Examples of the oxide solid electrolyte include an NASICON-type oxide, a garnet-type oxide, and a perovskite-type oxide. Examples of the NASICON-type oxide include oxides containing Li, Al, Ti, P and O (e.g., Li_{1.5}Al_{0.5}Ti_{1.5}(PO₄)₃). Examples of the garnet-type oxide include oxides containing Li, La, Zr and O (e.g., Li₇La₃Zr₂O₁₂). Examples of the perovskite-type oxide include oxides containing Li, La, Ti and O (e.g., LiLaTiO₃).

In addition, it is possible to appropriately replace the constituent elements in the above embodiment with well-known constituent elements without departing from the gist of the present invention, and the above-described modified examples may be appropriately combined.

### EXPLANATION OF REFERENCE NUMERALS

1 LITHIUM SECONDARY BATTERY

10 POSITIVE ELECTRODE

11 POSITIVE ELECTRODE CURRENT COLLECTOR

12 POSITIVE ELECTRODE MATERIAL MIXTURE LAYER

20 NEGATIVE ELECTRODE

21 NEGATIVE ELECTRODE CURRENT COLLECTOR

22 LITHIUM METAL FOIL

24 MAIN BODY

25 EXTENSION PORTION

30 SEPARATOR

31 THERMALLY DEFORMABLE SEPARATOR

51 FIRST EXTERIOR BODY

52 SECOND EXTERIOR BODY

55 CONVEX PORTION

61 FIRST PRESSURE PLATE

62 SECOND PRESSURE PLATE

65 PROJECTION PORTION

71 POSITIVE ELECTRODE TAB

72 NEGATIVE ELECTRODE TAB

What is claimed is:

1. A lithium secondary battery comprising: a positive electrode comprising a positive electrode current collector and a positive electrode material mixture layer disposed on a surface of the positive electrode current collector,
a negative electrode comprising a negative electrode current collector and a lithium metal foil disposed on a surface of the negative electrode current collector, and
a separator disposed between the positive electrode and the negative electrode,
wherein the lithium secondary battery comprises: a thermally deformable separator disposed in a vicinity of the positive electrode material mixture layer on the surface of the positive electrode current collector, and
an extension portion that extends from the lithium metal foil so as to be in contact with the thermally deformable separator;
the thermally deformable separator has a melting point of 80° C. or higher, which is equal to or lower than the melting point of lithium metal; and
when the thermally deformable separator thermally deforms, the extension portion comes into contact with the positive electrode current collector, resulting in a short circuit of the positive electrode and the negative electrode.

2. The lithium secondary battery according to claim 1, wherein the positive electrode current collector is an aluminum foil.

3. The lithium secondary battery according to claim 1, wherein the extension portion of the lithium metal foil comes into contact with the positive electrode current collector when the thermally deformable separator is thermally deformed by a restraint load that restrains the positive electrode, the separator, and the negative electrode.

4. The lithium secondary battery according to claim 3, wherein the lithium secondary battery comprises:
an exterior body housing the positive electrode, the negative electrode, and the separator; and
a pressure plate that applies the restraint load to pressurize the negative electrode toward the positive electrode side via the exterior body, and
the pressure plate has a projection portion that pressurizes, via the exterior body, the extension portion of the lithium metal foil toward the positive electrode current collector side outside the separator.

5. The lithium secondary battery according to claim 1, wherein the extension portion of the lithium metal foil is configured to curve or bend toward the positive electrode current collector side.

6. The lithium secondary battery according to claim 1, wherein the lithium secondary battery has a positive electrode tab having one end portion connected to the positive electrode current collector and an other end portion exposed to the outside, and
the extension portion of the lithium metal foil is disposed in a vicinity of the positive electrode tab.
